(19) United States
(12) Patent Application Publication
(10) Pub. No.: US 2019/0309548 A1
(43) Pub. Date: Oct. 10, 2019

(54) AIRCRAFT LATCH APPARATUS AND METHODS TO USE THE SAME

(71) Applicant: Harper Engineering Co., Renton, WA (US)

(72) Inventor: Richard J. LaConte, Renton, WA (US)

(21) Appl. No.: 16/366,889

(22) Filed: Mar. 27, 2019

Related U.S. Application Data
(60) Provisional application No. 62/653,264, filed on Apr. 5, 2018.

(51) Int. Cl. E05B 81/14; E05B 81/08

(52) U.S. Cl. CPC E05B 81/14; B64D 9/00; E05Y 2900/502; E05B 81/08

(57) ABSTRACT

A latch apparatus coupled to an aircraft component can comprise a latch assembly moveable between unlatched and latched configurations, an actuation system coupled to the latch assembly and operable to move the latch assembly from the latched configuration to the unlatched configuration, the actuation system including an electromagnet assembly magnetically coupled to the latch assembly, and a control system operably coupled to the electromagnet assembly. The control system can be configured to magnetically uncouple the electromagnet assembly from the latch assembly to cause the latch assembly to move from the latched configuration to the unlatched configuration. Related methods are also provided.

### BACKGROUND

### Technical Field

The present disclosure is generally related to latches that couple/decouple aircraft interior components.

### Description of the Related Art

Aircraft interior components, for example, stowage bins, galley doors, passenger service units, and doors or components thereof are typically secured via latches to attaching frame components. Such latches can comprise electrically actuated latches that include solenoids that draw large currents to maintain a latching configuration where the latch secures the interior component to the attaching frame. Other latches can comprise mechanically actuated latches that maintain a latching configuration via mechanical components that secure the interior component to the attaching frame. It is desirable to have aircraft interior component latches that include an electromechanical latch that reduces current draw, improves response time and efficiency, and provides robust and efficient form factors.

### BRIEF SUMMARY

Various implementations of latch apparatuses described herein improve efficiencies and response times by moving latch apparatuses between latched and unlatched configurations at reduced power requirements and short response times. Moreover, various implementations of latch apparatuses described herein provide robust and efficient form factors. For example, in one non-limiting, example implementation, a latch apparatus coupled to an aircraft component can comprise a latch assembly moveable between unlatched and latched configurations, an actuation system coupled to the latch assembly and operable to move the latch assembly from the latched configuration to the unlatched configuration, the actuation system including an electromagnet assembly magnetically coupled to the latch assembly, and a control system operably coupled to the electromagnet assembly. The control system can be configured to magnetically uncouple the electromagnet assembly from the latch assembly to cause the latch assembly to move from the latched configuration to the unlatched configuration.

In another non-limiting, example implementation, a latch apparatus coupleable to an aircraft component and having at least a latched configuration and an unlatched configuration can comprise a latch assembly including a release lever movable between a first release lever position in which the latch apparatus is in the unlatched configuration and a second release lever position in which the latch apparatus is in the latched configuration, and a lever arm coupled to the release lever. The latch apparatus can also comprise a control system operable to generate a short pulse of electrical power, and an actuation system operably coupled to the control system, the actuation system including an electromagnet assembly. The electromagnet assembly can include a ferromagnetic core, an electromagnetic coil surrounding the ferromagnetic core to generate a magnetic flux, and a permanent magnet, the short pulse of electrical power magnetically uncoupling the permanent magnet from the lever arm by generating the magnetic flux in the electromagnetic coil of a polarity opposite to a polarity of a magnetic flux of the permanent magnet, which causes rotary movement of the lever arm to move the release lever from the second release lever position to the first release lever position.

In another non-limiting, example implementation, a method for latching a payload component of an aircraft can comprise rotating a strike member in a first rotary direction from an unlatched strike position to a latched strike position by contacting a structure of the aircraft with the strike member, and maintaining the latched strike position by coupling an electromagnet assembly having a permanent magnet and an electromagnet coil to a lever arm coupled to the strike member. The method can also comprise unlatching the payload component by uncoupling the lever arm from the electromagnet assembly by delivering a short pulse of electrical power to the electromagnet assembly, the delivering generating a current induced magnetic flux in the electromagnet coil of a polarity opposite to a polarity of a magnetic flux generated by the permanent magnet to cause the lever arm to rotatably move the strike member in a second rotary direction from the latched strike position to the unlatched strike position.

### BRIEF DESCRIPTION OF THE SEVERAL VIEWS OF THE DRAWINGS

FIG. 1 is an isometric view of a latch apparatus, according to one example, non-limiting implementation, illustrating the latch apparatus in an unlatched configuration.

FIG. 2 is an exploded view of the latch apparatus of FIG. 1.

FIG. 3 is an isometric view of an outer cover member of a housing assembly of the latch apparatus of FIG. 1.

FIG. 4 is an isometric view of a release lever of a latch assembly of the latch apparatus of FIG. 1.

FIG. 5 is a cross-sectional view of the latch apparatus of FIG. 1, taken along lines 5-5.

FIG. 6 is a front elevational view of the latch apparatus of FIG. 1, with certain components removed for clarity of description and illustration, illustrating the latch apparatus in an unlatched configuration.

FIG. 7 is another front elevational view of the latch apparatus of FIG. 1, with still further certain components removed for clarity of description and illustration, illustrating the latch apparatus in the unlatched configuration.

FIG. 8 is a rear elevational view of the latch apparatus of FIG. 1, with certain components removed for clarity of description and illustration, illustrating the latch apparatus in the unlatched configuration.

FIG. 9 is a front elevational view of the latch apparatus of FIG. 1, with certain components removed for clarity of description and illustration, illustrating the latch apparatus in an intermediate latched configuration.

FIG. 10 is a front elevational view of the latch apparatus of FIG. 1, with certain components removed for clarity of description and illustration, illustrating the latch apparatus in a latched configuration.

FIG. 11 is another front elevational view of the latch apparatus of FIG. 1, with still further certain components removed for clarity of description and illustration, illustrating the latch apparatus in the latched configuration.

FIG. 12 is a rear elevational view of the latch apparatus of FIG. 1, with certain components removed for clarity of description and illustration, illustrating the latch apparatus in the latched configuration.

FIG. 13 is a front elevational view of the latch apparatus of FIG. 1, with certain components removed for clarity of description and illustration, illustrating the latch apparatus in an unlatching configuration.

FIG. 14 is another front elevational view of the latch apparatus of FIG. 1, with still further certain components removed for clarity of description and illustration, illustrating the latch apparatus in the unlatching configuration.

FIG. 15 is a rear elevational view of the latch apparatus of FIG. 1, with certain components removed for clarity of description and illustration, illustrating the latch apparatus in the unlatching configuration.

FIG. 16 is a skewed front isometric view of the latch apparatus of FIG. 1, with certain components removed for clarity of description and illustration, illustrating the latch apparatus in an intermediate unlatching configuration.

### DETAILED DESCRIPTION

In the following description, certain specific details are set forth in order to provide a thorough understanding of various disclosed embodiments or implementations. However, one skilled in the relevant art will recognize that embodiments or implementations may be practiced without one or more of these specific details, or with other methods, components, materials, etc. In other instances, well-known structures associated with payload components, latches, aircraft power or electrical systems, or other systems and apparatuses of aircrafts have not been shown or described in detail to avoid unnecessarily obscuring descriptions of the embodiments or implementations.

Unless the context requires otherwise, throughout the specification and claims which follow, the word “comprise” and variations thereof, such as “comprises” and “comprising,” are to be construed in an open, inclusive sense, that is, as “including, but not limited to.”

Reference throughout this specification to “one embodiment,” “one implementation,” “an embodiment,” or “an implementation” means that a particular feature, structure or characteristic described in connection with the embodiment or implementation is included in at least one embodiment or implementation. Thus, the appearances of the phrases “in one embodiment,” “in one implementation,” “in an embodiment,” or “in an implementation” in various places throughout this specification are not necessarily all referring to the same embodiment or implementation. Furthermore, the particular features, structures, or characteristics may be combined in any suitable manner in one or more embodiments or implementations.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

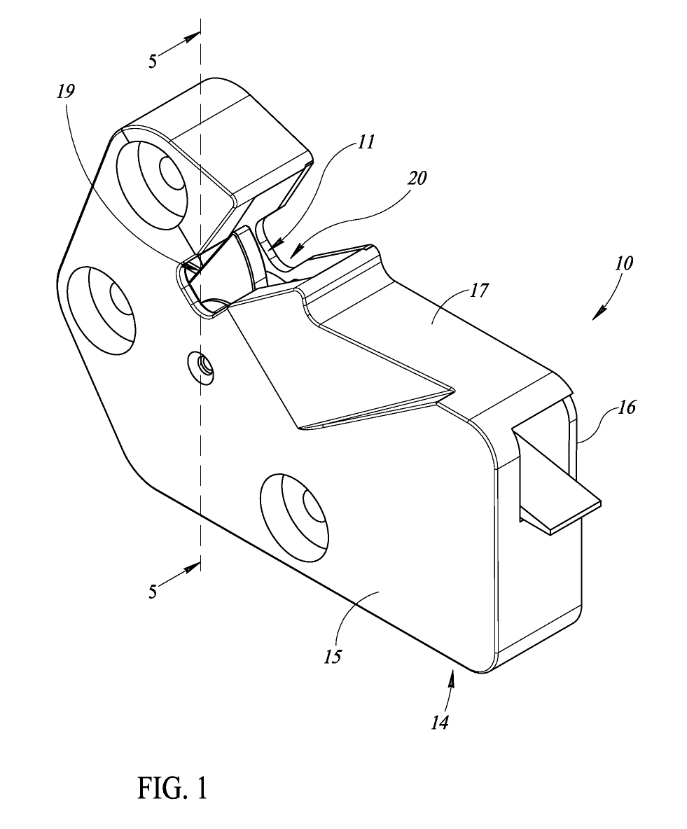

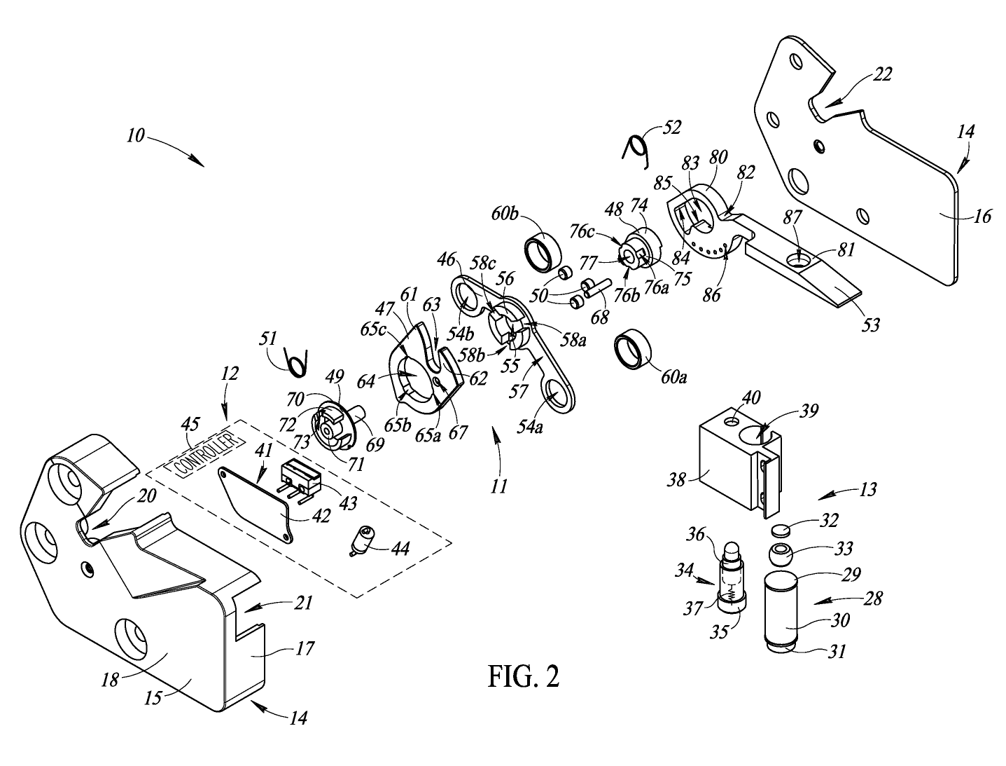

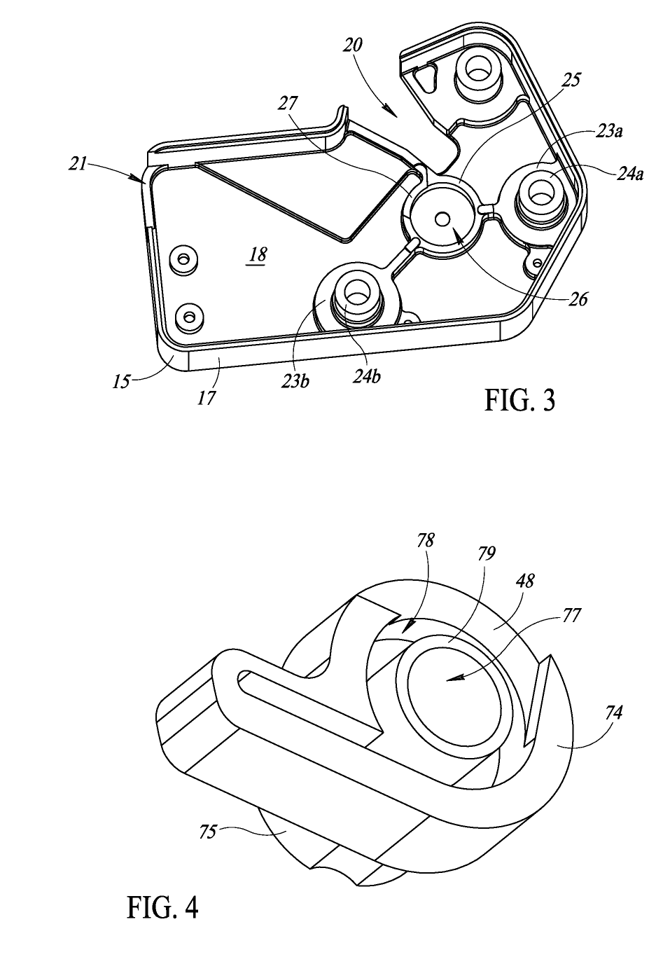

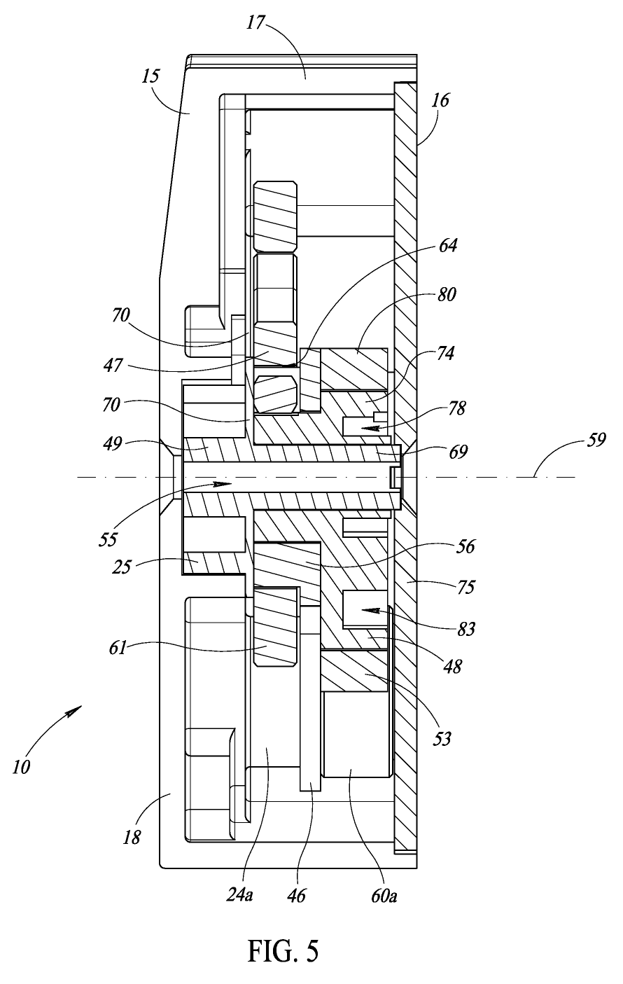

FIGS. 1 through 5 illustrate a latch apparatus 10 according to one example, non-limiting implementation. The latch apparatus 10 is operable to couple to various payload components of an aircraft, such as, for example, aircraft stowage bins, doors, passenger service units, etc. In general, the latch apparatus 10 facilitates opening or closing of various components of the payload components, such as, for example, a bin bucket, a door frame, etc., which are coupled to respective aircraft frame structures.

The latch apparatus 10 includes a latch assembly 11, a control system 12, an actuation system 13, and a housing assembly 14 that is sized and shaped to house components of the latch assembly 11, the control system 12, and the actuation system 13. The housing assembly 14 includes an outer cover member 15 and a plate member 16 coupleable to the outer cover member 15. The outer cover member 15 includes an outer wall 17 that protrudes outwardly from a cover portion 18. The plate member 16 is sized and shaped to match a peripheral profile of the outer wall 17, such that when the plate member 16 is coupled to the outer wall 17, the plate member 16 is seated within the outer cover member 15 adjacent to an edge of the outer wall 17. In this manner, the coupling of the plate member 16 to the outer wall 17 defines an interior space 19 within which one or more components of the latch assembly 11, the control system 12, and the actuation system 13 are housed.

As illustrated in FIGS. 1-3, the outer wall 17 includes a wall strike engagement cavity 20 located adjacent to an end of the outer cover member 15. As will be described in more detail below, the wall strike engagement cavity 20 is sized and shaped to allow rotatable movement of component(s) of the latch assembly 11 therein. The outer wall 17 also includes a lever arm cavity 21 that extends therethrough, which is sized and shaped to allow rotatable movement of component(s) of the latch assembly 11 therein. The plate member 16 includes a strike engagement cavity 22 that extends therethrough. The profile of the wall engagement strike cavity 20 and the profile of the strike engagement cavity 22 are substantially similar to each other.

The outer cover member 15 includes a pair of stator projections 23a, 23b that are angularly spaced apart relative to a pivot projection 25 and protrude outwardly from the cover portion 18. Each stator projection 23a, 23b includes coupling portions 24a, 24b. The pivot projection 25 also protrudes outwardly from the cover portion 18 and includes a cavity 26 which defines a pivot wall 27.

The actuation system 13 includes an electromagnet assembly 28 having a primary ferromagnetic core 29 with an electromagnetic coil 30 wound therearound, and a permanent magnet 31. The permanent magnet 31 is mounted at one end of the primary ferromagnetic core 29. The electromagnet assembly 28 also includes a secondary magnet 32 mounted on a secondary ferromagnetic core 33. The secondary magnet 32 is magnetically coupleable to the primary ferromagnetic core 29 at another end which is opposite to the end with the permanent magnet 31 via the magnetic flux generated by the permanent magnet 31. The secondary magnet 32 is oriented to have a polarity that is the same as a polarity of the current induced magnetic flux caused by inducing current in the primary ferromagnetic core 29 via the electromagnetic coil 30, but different from a polarity of the permanent magnet 31. In this manner, the magnetic flux caused by the permanent magnet 31 attracts the secondary magnet 32, while the current induced magnetic flux repels the secondary magnet 32 away from the permanent magnet 31.

The actuation system 13 also includes a plunger assembly 34. The plunger assembly 34 includes a plunger housing 35 that is sized and shaped to receive a plunger 36. The plunger 36 is coupled to a biasing member 37, e.g., a linear spring, that biases the plunger 36 away from a lower surface of the plunger housing 35.

The plunger assembly 34 and the electromagnet assembly 28 are received in a magnet housing 38. In particular, the magnet housing 38 includes a first aperture 39 that is sized and shaped to receive therein the ferromagnetic core 29, the electromagnetic coil 30 wound around the ferromagnetic core 29, and the permanent magnet 31 of the electromagnet assembly 28. The magnet housing 38 also includes a plunger aperture 40 that is sized and shaped to receive therein the plunger assembly 34. The magnet housing 38 is sized and shaped to be received in the interior space 19 of the housing assembly 14. The magnet housing 38 can be coupled to the housing assembly 14 via fastening, adhering, or other coupling structures.

The control system 12 includes circuitry 41, for example, mounted on one or more printed circuit boards (PCBs) 42, one or more switches 43, one or more diodes 44, etc. The control system 12 is operable to control latching and/or unlatching functionality of the latch apparatus 10 via the actuation system 13. For example, the circuitry 41 can be coupled to a power supply, which provides a short pulse of electrical power to generate current induced magnetic flux around the electromagnetic coil 30 upon activation of a switch mounted on a payload component, such as a stowage bin. This current induced magnetic flux operates to balance, cancel, or negate the magnetic flux generated by the permanent magnet 31. In some implementations, the short pulse can comprise 5 milliseconds at 18 volts. In other implementations, the short pulse can comprise 3 milliseconds at 28 volts. Other pulse durations that provide a short pulse at corresponding voltages are within the scope of the disclosed subject matter.

Further, as described above, the secondary magnet 32 is oriented and/or positioned to have the same polarity as the polarity of the current induced magnetic flux, which causes the secondary magnet 32 to move away from the primary ferromagnetic core 29 upon the balancing, cancelling, or negating of the magnetic flux generated by the permanent magnet 31.

In some implementations, the control system 12 may also include a controller 45 that operates to communicate with the latch apparatus 10, including the actuation system 13. The controller 45 may take a wide variety of forms, which may include one or more integrated circuits, integrated circuit components, digital circuits, digital circuit components, analog circuits, analog circuit components, and various combinations thereof. The controller 45 can include a microcontroller, non-transitory computer- or processor-readable memory such as a read only memory (ROM) and/or random access memory (RAM), and may optionally include one or more gate drive circuits.

The controller 45, for example, a microcontroller executes logic to control operation of the control system 12, and may take a variety of forms. For example, the microcontroller may take the form of a microprocessor, programmed logic controller (PLC), programmable gate array (PGA) such as a field programmable gate array (FPGS), an application specific integrated circuit (ASIC), or other such microcontroller device. The ROM may take any variety of forms capable of storing processor executable instructions and/or data to implement the control logic. The RAM may take any variety of forms capable of temporarily retaining processor executable instructions or data. The microcontroller, ROM, RAM and optional gate drive circuit(s) may be coupled by one or more buses, including power buses, instructions buses, data buses, address buses, etc. Alternatively, the control logic may be implemented in an analog circuit.

In some embodiments or implementations, the instructions and/or data stored on the non-transitory storage mediums that may be used by the controller, such as, for example, ROM, RAM and Flash memory, includes or provides an application program interface (“API”) that provides programmatic access to one or more functions of the control system 12. For example, such an API may provide a programmatic interface to control one or more operational characteristics of the control system 12, including, but not limited to, one or more functions of sensor(s), actuators or their controllers and user interface. Such control may be invoked by one of the other programs, sensors, actuators, other remote device or system, or some other module. In this manner, the API may facilitate the development of third-party software, such as various different user interfaces and control systems for other devices, plug-ins, and adapters (e.g., for integrating functions of various devices in the control system 12), and the like to facilitate interactivity and customization of the operation and devices within the control system 12.

In some implementations, the controller 45 can communicate with the actuation system 13 by sending control signals to provide electrical power as described above to unlatch the latch assembly 11. The controller 45 can communicate with the actuation system 13 by sending control signals to lock the latch assembly 11, such that activation of the switch mounted on a payload component, such as a stowage bin, may not unlatch the latch assembly 11. In some implementations, the controller 45 can communicate with indicators mounted on the payload component to identify the latching/unlatching state, or other status indicators. For example, the indicator(s) may take the form of one or more LEDs, audio speakers, etc., which may identify if the payload component is latched, unlatched, locked, open, etc. The controller 45 may communicate with the various components described herein via wired connections or wirelessly. For example, the controller 45 may include a communications sub-system that includes wireless receivers, wireless transmitters or wireless transceivers to provide wireless signal paths to the various remote components or systems of the latch assembly 11 or the actuation system 13. The communications sub-system may, for example, include components enabling short range (e.g., via Bluetooth, near field communication (NFC), radio frequency identification (RFID) components and protocols) or longer range wireless communications (e.g., over a wireless LAN, Low-Power-Wide-Area Network (LPWAN), satellite, or cellular network), such as for receiving GPS data, and may include one or more modems or one or more Ethernet or other types of communications cards or components for doing so.

The latch assembly 11 includes a stator device 46, a strike member 47, a release lever 48, a pivot base member 49, one or more rollers 50, a strike biasing member 51, a release lever biasing member 52, and a lever arm 53, which components are generally positioned within the interior space 19 of the housing assembly 14.

The stator device 46 has a generally boomerang shape, although other shapes and sizes are within the scope of the disclosed subject matter. In general, the stator device 46 includes a pair of end apertures 54a, 54b and a center aperture 55. The center aperture 55 is generally aligned or concentric with a center wall 56 that protrudes outwardly from a surface 57 of the stator device 46. The center wall 56 includes a plurality of recesses 58a, 58b, 58c that are radially spaced apart relative to a center of the center aperture 55, which center defines a pivot axis 59. The stator device 46 is sized and shaped to be fixedly coupled to the housing assembly 14. In particular, the end apertures 54a, 54b are sized and shaped to coupleably receive therethrough corresponding coupling portions 24a, 24b. In some implementations, the latch assembly 11 optionally includes a pair of spacers 60a, 60b that are coupled to the coupling portions 24a, 24b, and which sandwich the stator device 46 therebetween. Thus, when the stator device 46 is coupled to the cover portion 18 of the outer cover member 15, a center of the center wall 56 of the stator device 46 is generally aligned with a center of the pivot projection 25 that protrudes outwardly from the cover portion 18.

The strike member 47 includes a strike body 61 having a latch hook portion 62 that is, at least partially, defined by a pin notch 63 that extends through the strike body 61. The strike body 61 includes a pivot aperture 64 and a plurality of strike notches 65a, 65b, 65c. The pivot aperture 64 is sized and shaped to surround the center wall 56, and extends through the strike body 61. The strike notches 65a, 65b, 65c are radially spaced apart relative to a center of the pivot aperture 64, which center of the pivot aperture 64 is generally aligned or concentric with the pivot axis 59. The strike body 61 includes a strike pin aperture 67 that extends therethrough and is sized and shaped to coupleably receive therethrough a strike pin 68.

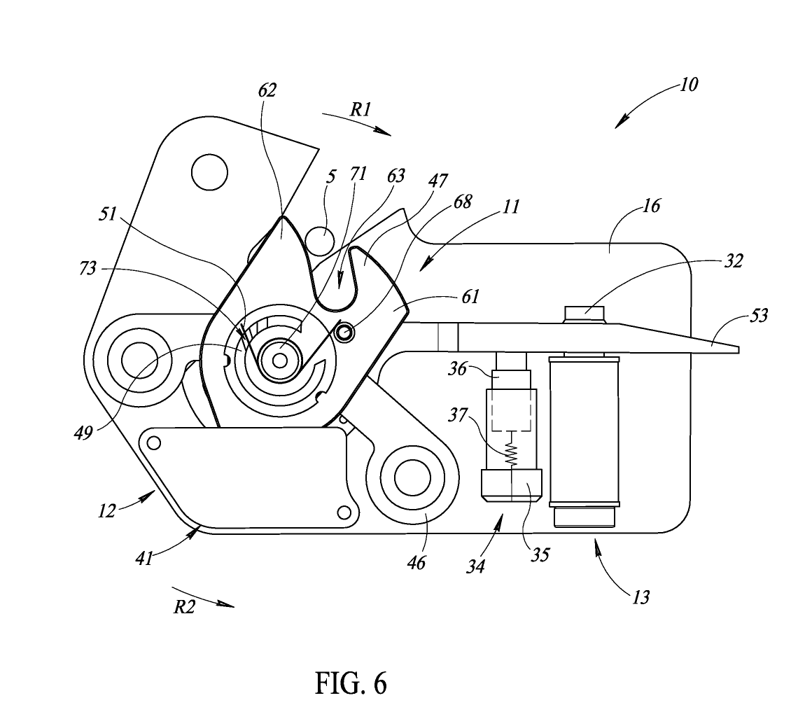

The pivot base member 49 includes a first shaft member 69 extending outwardly from a partition wall 70, and a second shaft member 71 extending outwardly from the partition wall 70 in an opposite direction. The second shaft member 71 is surrounded by a first spring wall 72, which includes one or more spring notches 73. The pivot base member 49 is coupled to the strike member 47, with the partition wall 70 abutting a surface of the strike body 61 and the first shaft member 69 protruding through the center of the pivot aperture 64 and generally aligned or concentric with the pivot axis 59. The strike biasing member 51, e.g., a torsion spring, is coupled to the pivot base member 49 and the strike member 47. In particular, strike biasing member 51 coupleably surrounds the second shaft member 71, and includes one end that is received through one of the one or more spring notches 73, and another end that rests against a surface of the strike pin 68 that is coupled to the strike body 61 (see, e.g., FIG. 6).

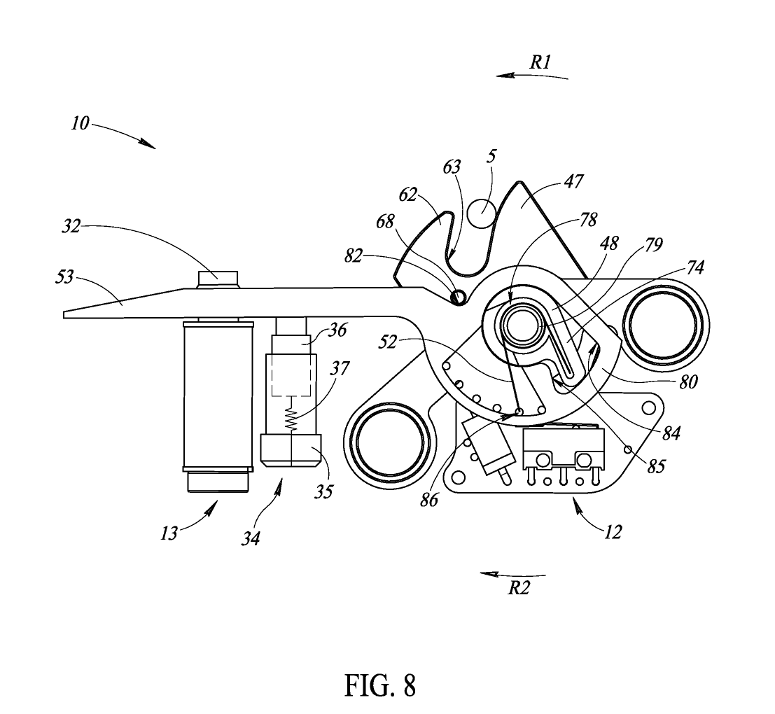

The release lever 48 has a lever body 74 that has a substantially b-shaped structure, although other shapes and sizes are within the scope of the disclosed subject matter. The lever body 74 includes a lever shaft 75 that protrudes outwardly from a radial surface of the lever body 74 and includes a plurality of radially spaced apart lever notches 76a, 76b, 76c. The lever body 74 includes a lever aperture 77 that extends therethrough. The lever notches 76a, 76b, 76c are radially spaced apart relative to a center of the lever aperture 77. On an opposite side of the lever shaft 75, the lever body 74 includes a lever biasing recess 78 that partially extends through the lever body 74. A lever wall 79 extends outwardly from the lever body 74. The lever biasing recess 78 is sized and shaped to coupleably receive the release lever biasing member 52, e.g., a torsion spring. In particular, the release lever biasing member 52 is coupled to the release lever 48, with the release lever biasing member 52 surrounding the lever wall 79. One end of the release lever biasing member 52 is coupleably received at one end of the lever biasing recess 78, and another end of the release lever biasing member 52 protrudes outwardly and away from the release lever 48 from another end of the lever biasing recess 78 (see, e.g., FIG. 8).

The release lever 48 is pivotably coupled to the stator device 46 and the strike member 47 about a center of lever aperture 77. In particular, the first shaft member 69 of the pivot base member 49 pivotably extends through the pivot aperture 64 of the strike member 47, the center aperture 55 of the stator device 46, and the lever aperture 77. In this manner, the release lever 48 is pivotably rotatable about the pivot axis 59 with respect to the pivot base member 49, the stator device 46, and the strike member 47. In a similar manner, the strike member 47 is pivotably rotatable about the pivot axis 59 with respect to the pivot base member 49, the stator device 46, and the release lever 48.

The lever arm 53 includes a radial portion 80 and an arm portion 81. The radial portion 80 has a substantially arcuate shape and extends to the arm portion 81 via a pin receiving surface 82. The radial portion 80 includes a lever cavity 83. The lever cavity 83 has a substantially arcuate shape, which is similar to the shape of the release lever 48, and is sized and shaped to allow the release lever 48 to rotatably move therein. The lever cavity 83 defines an end surface 84 and a contact surface 85. The radial portion 80 also includes a plurality of spring apertures 86. The spring apertures 86 are sized and shaped to coupleably receive therein an end of the release lever biasing member 52 that extends away from the release lever 48 (see, e.g., FIG. 8). The arm portion 81 of the lever arm 53 includes a magnet aperture 87 that extends therethrough. The magnet aperture 87 is sized and shaped to coupleably receive therein the secondary magnet 32 mounted on the secondary ferromagnetic core 33. The arm portion 81 of the lever arm 53 is moveable in the lever arm cavity 21 of the outer cover member 15.

The lever arm 53 is positioned adjacent to the stator device 46. As described above, the lever body 74 of the release lever 48 is received in the lever cavity 83. The lever arm 53 is pivotably moveable about the pivot axis 59 with respect to the lever body 74 as the arm portion 81 rotates due to the magnetic forces caused by the electromagnet assembly 28, as described above and discussed in further detail below.

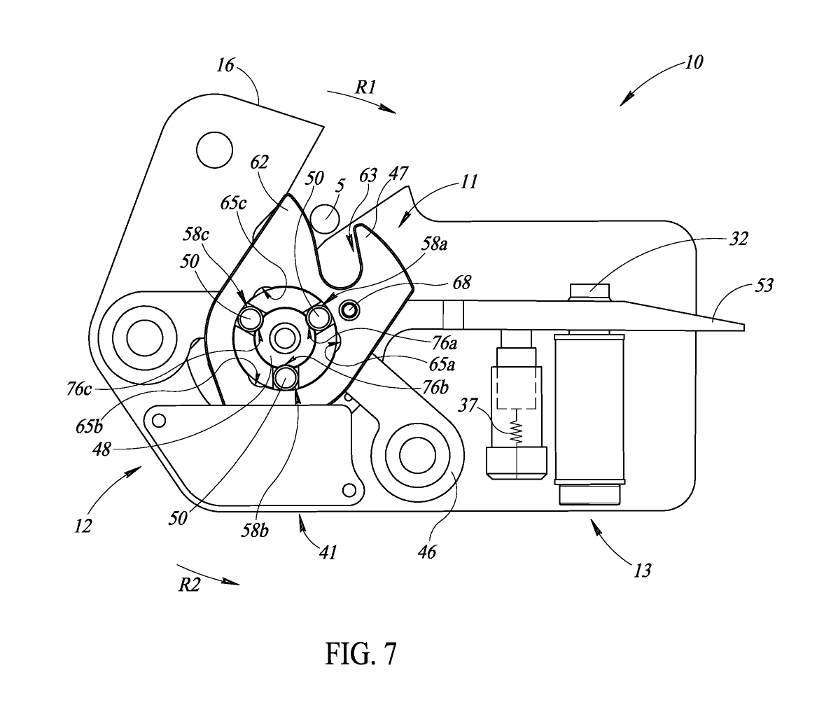

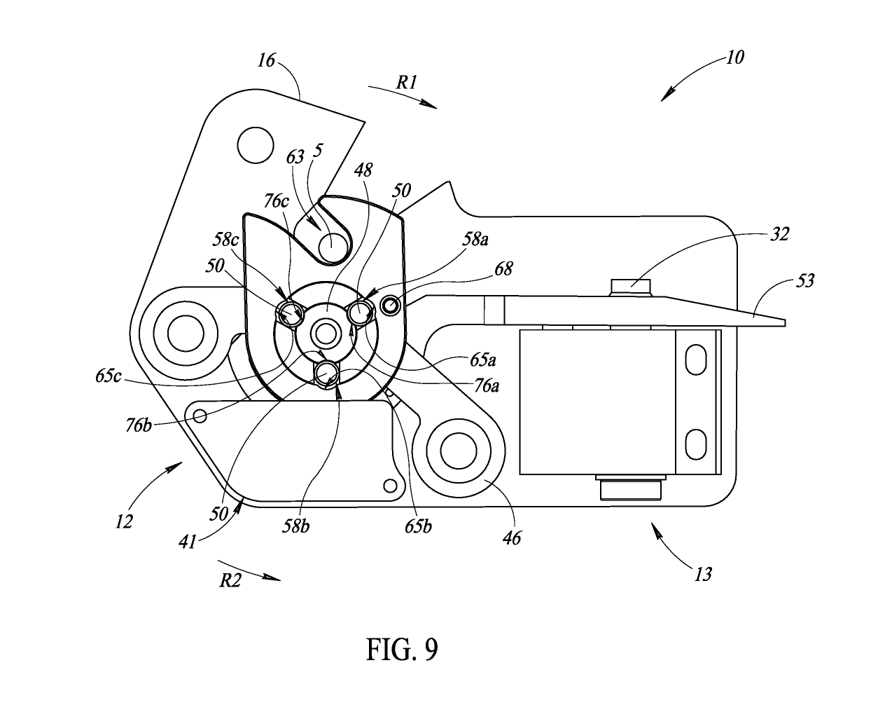

FIGS. 6-16 illustrate various operational stages and configurations of the latch apparatus 10. With reference to FIGS. 6-9, FIGS. 6-8 illustrate the latch apparatus 10 in an unlatched configuration, and FIG. 9 illustrates the latch apparatus in an intermediate latched configuration. In FIG. 6, the outer cover member 15 has been removed, in FIG. 7 the pivot base member 49 and the strike biasing member 51 have been removed, and in FIG. 8 the outer cover member 15 and the plate member 16 have been removed, such components being removed for clarity of illustration and description.

As illustrated in FIG. 6, in the unlatched configuration, the strike member 47 is in a first strike rotary position, in which the strike member 47 is rotationally positioned toward the lever arm 53. The strike biasing member 51 is coupled to the pivot base member 49, surrounding the second shaft member 71, with one end received through one of the one or more spring notches 73, and another end resting against a surface of the strike pin 68 that is coupled to the strike body 61. In this unlatched configuration with the strike member 47 being in the illustrated first strike rotary position, the strike biasing member 51 is in an unlatched position or a decompressed position, with the strike biasing member 51 configured to bias the strike member 47 in a first rotary direction R1 when the strike biasing member 51 is in a compressed position.

As illustrated in FIG. 7, in the unlatched configuration, the one or more rollers 50 are positioned in the recesses 58a, 58b, 58c of the stator device 46 and are aligned with the lever notches 76a, 76b, 76c of the release lever 48. However, in the unlatched configuration, the strike member 47 is in the first rotary position in which the strike notches 65a, 65b, 65c are not aligned with the rollers 50 in the recesses 58a, 58b, 58c.

As illustrated in FIG. 8, in the unlatched configuration, the release lever 48 is in a first lever rotary position. As described above, the release lever biasing member 52 is coupled to the release lever 48 with the release lever biasing member 52 surrounding the lever wall 79. One end of the release lever biasing member 52 is coupleably received at one end of the lever biasing recess 78 and another end of the release lever biasing member 52 protruding outwardly and away from the release lever 48 from another end of the lever biasing recess 78, and being coupleably received in the spring aperture 86 of the radial portion 80 of the lever arm 53. Moreover, in this unlatched configuration with the release lever 48 being in the illustrated first lever rotary position, the release lever biasing member 52 is in an unlatched position or in a compressed position, with the release lever biasing member 52 configured to bias the release lever 48 in the first rotary direction R1 to a decompressed position described in further detail below.

In the unlatched configuration with the release lever 48 being in a first lever rotary position, the lever body 74 is positioned adjacent to contact surface 85 and away from end surface 84. Moreover, in the unlatched configuration, the strike pin 68 is received in the pin receiving surface 82 of the lever arm 53.

With continued reference to FIGS. 6-8 and reference to FIG. 9, the strike member 47 is configured to engage a structure 5, e.g., a pin, disposed in in a payload component or its attaching frame structure, which structure 5 is accessible to the strike member 47 via the wall engagement strike cavity 20 and the strike engagement cavity 22 of the housing assembly 14. In particular, the structure 5 is received in the pin notch 63 disposed in the strike member 47, more specifically, in the latch hook portion 62. Such contact with the structure 5 causes the strike member 47 to rotate in the second rotary direction R2 and counter to the biasing forces caused by the strike biasing member 51 urging the strike member 47 to rotate in the first rotary direction R1. As the strike member 47 rotates in the second rotary direction R2, the recesses 58a, 58b, 58c of the stator device 46 and consequently the rollers 50 positioned therein, align with the strike notches 65a, 65b, 65c of the strike member 47, as illustrated in FIG. 9. In this intermediate latched configuration illustrated in FIG. 9, the release lever biasing member 52, being in a compressed position, overcomes the frictional forces resulting from the misalignment of the rollers 50 with the strike notches 65a, 65b, 65c and the lever notches 76a, 76b, 76c, and urges the release lever 48 to rotate in the first rotary direction R1. As the release lever 48 rotates in the first rotary direction R1, the rollers 50 in the recesses 58a, 58b, 58c are moved into the strike notches 65a, 65b, 65c in the strike member 47 and out of the lever notches 76a, 76b, 76c, which moves the latch apparatus 10 into the latched configuration.

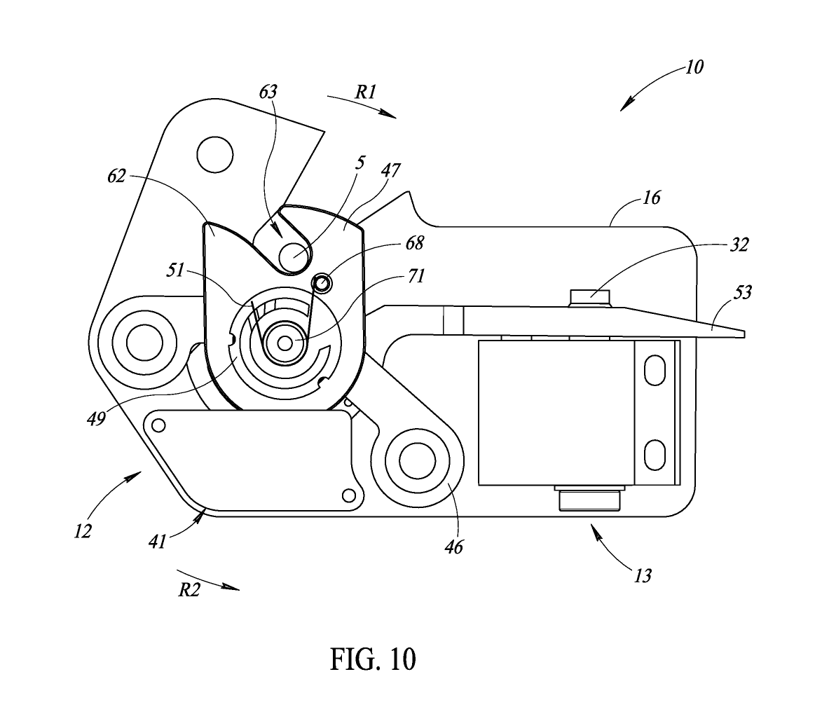

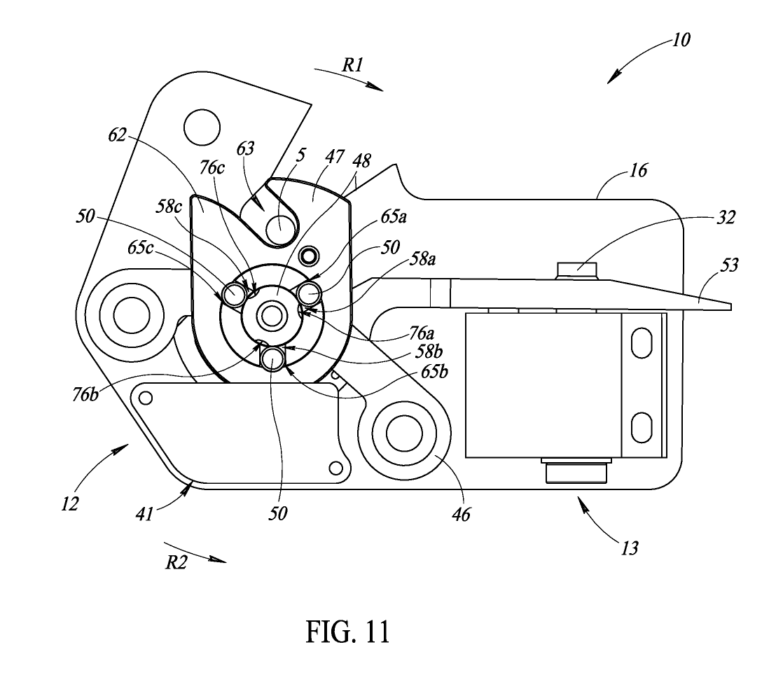

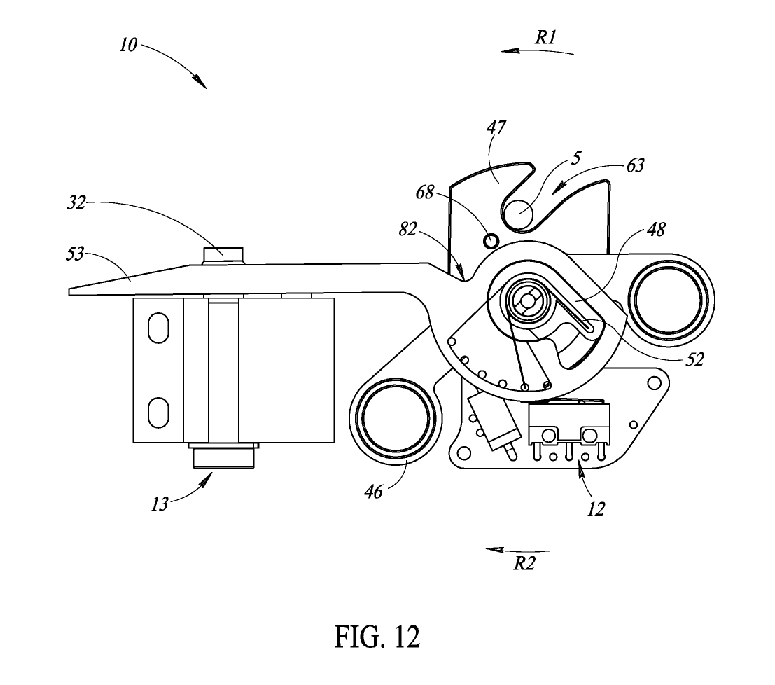

FIGS. 10-12 illustrate the latch apparatus 10 in the latched configuration. In FIG. 10, the outer cover member 15 has been removed, in FIG. 11 the pivot base member 49 and the strike biasing member 51 have been removed, and in FIG. 12 the outer cover member 15 and the plate member 16 have been removed, such components being removed for clarity of illustration and description.

As illustrated in FIG. 10, in the latched configuration, the structure 5 is positioned in the pin notch 63, and the strike member 47 is in a second strike rotary position, in which the strike member 47 is rotationally positioned in an upright position, away from the lever arm 53. The strike biasing member 51 is in a latched position or compressed position, with the strike biasing member 51 configured to bias the strike member in the first rotary direction R1 to the decompressed position.

As illustrated in FIG. 11, in the latched configuration, the one or more rollers 50 are positioned in the recesses 58a, 58b, 58c of the stator device 46, and are aligned with the strike notches 65a, 65b, 65c of the strike member 47. However, in the latched configuration, the release lever 48 is in a second lever rotary position, in which the lever notches 76a, 76b, 76c of the release lever 48 are not aligned with the rollers 50 in the recesses 58a, 58b, 58c.

As further illustrated in FIG. 12, in the latched configuration, the release lever 48 is in the second lever rotary position, in which the release lever biasing member 52 is in a latched position or in a decompressed position, with the release lever biasing member 52 configured to bias the release lever 48 in the first rotary direction R1 when in the compressed position. Moreover, when the strike member 47 is in the second strike rotary position, the strike pin 68 is positioned out of the pin receiving surface 82 of the lever arm 53.

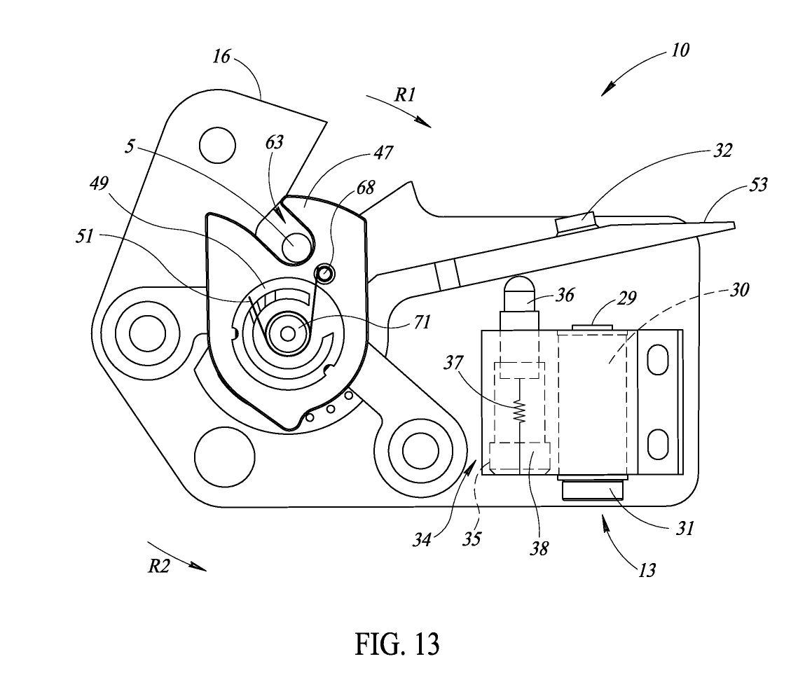

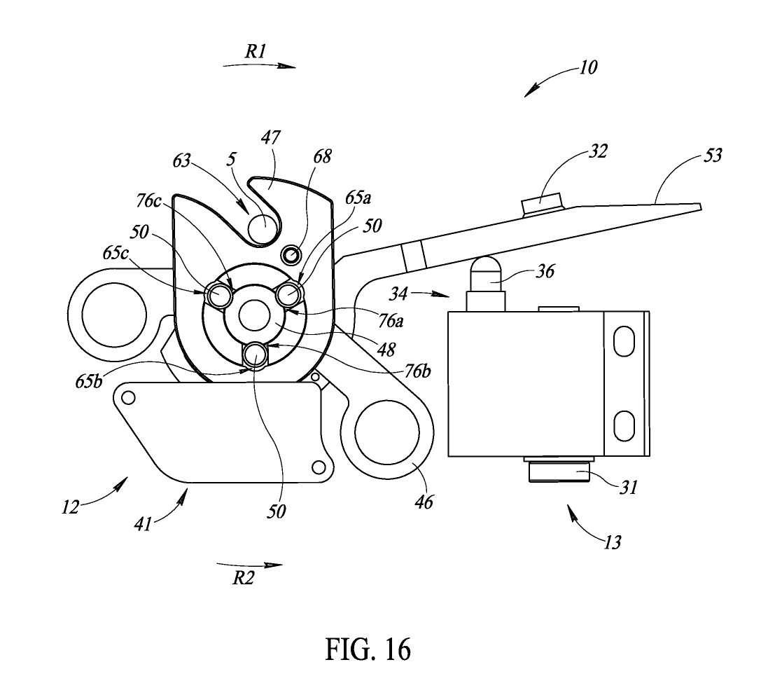

FIGS. 13-15 illustrate the latch apparatus 10 in an unlatching configuration, and FIG. 16 illustrates the latch apparatus 10 in an intermediate unlatching configuration. As described above, the latch apparatus 10 includes the actuation system 13 that is communicably and electrically coupled to the control system 12. In order to switch or move the latch apparatus 10 from the latched configuration illustrated in FIGS. 10-12 to the unlatched configuration illustrated in FIGS. 6-8, as described above, a short pulse of electrical power is provided to the actuation system 13 to generate current induced magnetic flux around the electromagnetic coil 30 upon activation of a switch mounted on a payload component, such as a stowage bin. This current induced magnetic flux operates to balance, cancel, or negate the magnetic flux generated by the permanent magnet 31.

With the magnetic flux generated by the permanent magnet 31 negated, the plunger assembly 34 facilitates rotating the lever arm 53 in the second rotary direction R2, away from the magnet housing 38. In particular, the biasing member 37 urges the plunger 36 away from a lower surface of the plunger housing 35.

Moreover, as described above, the secondary magnet 32 is oriented and/or positioned to have the same polarity as the polarity of the current induced magnetic flux, which causes the secondary magnet 32 to move away from the primary ferromagnetic core 29 upon the balancing, cancelling, or negating of the magnetic flux generated by the permanent magnet 31. This movement of the secondary magnet 32 advantageously provides an additional rotary force to move the lever arm 53 away from the magnet housing 38.

As illustrated in FIG. 13, the structure 5 is positioned in the pin notch 63, and the strike member 47 is in the second strike rotary position, in which the strike member 47 is rotationally positioned in an upright position, away from the lever arm 53. The strike biasing member 51 is in the latched position or compressed position, with the strike biasing member 51 configured to bias the strike member in a first rotary direction R1 to the decompressed position.

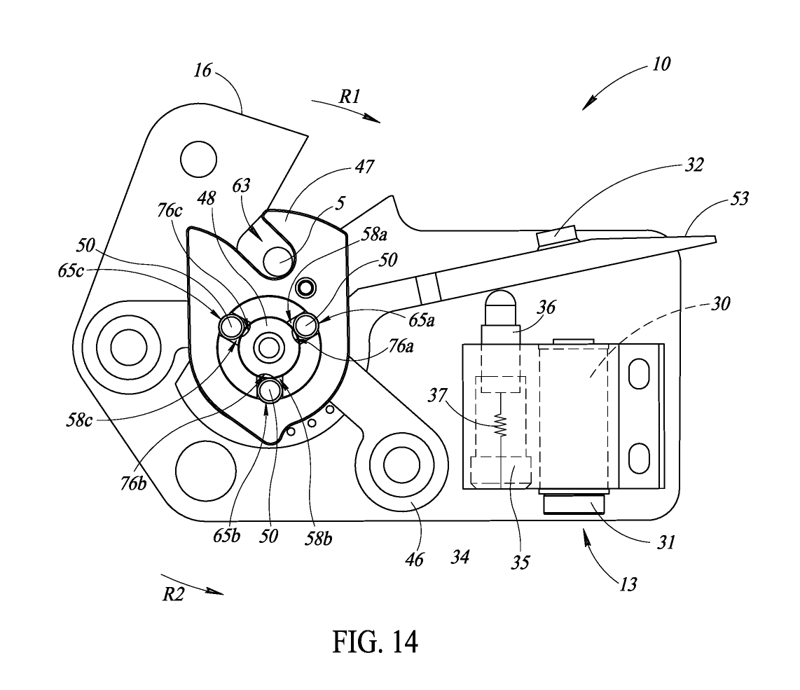

As illustrated in FIG. 14, the one or more rollers 50 are positioned in the recesses 58a, 58b, 58c of the stator device 46 and are aligned with the strike notches 65a, 65b, 65c of the strike member 47. However, the lever notches 76a, 76b, 76c of the release lever 48 are not aligned with the rollers 50 in the recesses 58a, 58b, 58c.

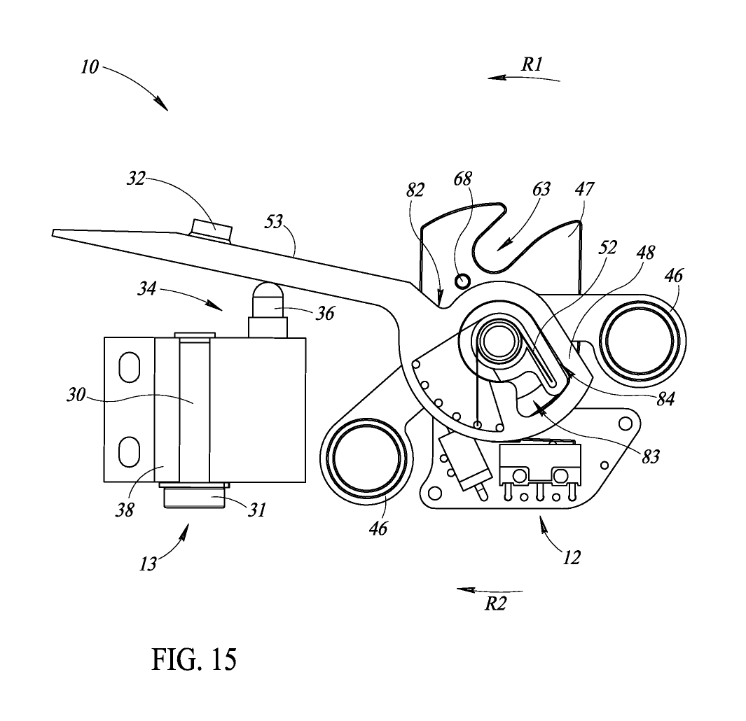

As illustrated in FIG. 15, as the lever arm 53 rotates in the second rotary direction R2, the release lever 48 in the second lever rotary position is positioned in the lever cavity 83 such that the release lever 48 is positioned adjacent to the end surface 84. The rotation of the lever arm 53 in the second rotary direction R2 causes the release lever 48 to rotatably move therewith as the end surface 84 contacts the release lever 48.

As illustrated in FIG. 16, which shows an intermediate unlatching configuration of the latch apparatus 10, the rotation of the release lever 48 aligns the lever notches 76a, 76b, 76c with the recesses 58a, 58b, 58c in the stator device 46, and consequently with the rollers 50 and the strike notches 65a, 65b, 65c of the strike member 47. In this intermediate unlatching configuration, the strike biasing member 51 being in the latched position or compressed position overcomes the frictional forces resulting from the misalignment of the rollers 50 with the strike notches 65a, 65b, 65c and the lever notches 76a, 76b, 76c, and urges the strike member 47 to rotate in the first rotary direction R1. As the strike member 47 rotates in the first rotary direction R1, the rollers 50 in the recesses 58a, 58b, 58c are moved into the lever notches 76a, 76b, 76c of the release lever 48 and out of the strike notches 65a, 65b, 65c in the strike member 47, which moves the latch apparatus 10 into the unlatched configuration illustrated in FIGS. 6-8, wherein the strike member 47 returns to the first strike rotary position and the release lever 48 returns to the first lever rotary position. Moreover, as the strike member 47 rotates in the first rotary direction R1, the strike pin 68 moves into the pin receiving surface 82 and consequently rotates the lever arm 53 in the first rotary direction R1 until the lever arm 53 is positioned adjacent to the magnet housing 38. Again, in this unlatched configuration, the magnetic flux caused by the permanent magnet 31 magnetically couples the lever arm 53 and/or the secondary magnet 32 thereto. Thereafter, as the structure 5 is positioned out of the pin notch 63, the payload component is unsecure and can be moved or opened appropriately.

Moreover, the various embodiments or implementations described above can be combined to provide further embodiments or implementations. These and other changes can be made to the embodiments or implementations in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A latch apparatus coupled to an aircraft component, the latch apparatus comprising:
a latch assembly moveable between unlatched and latched configurations;
an actuation system coupled to the latch assembly and operable to move the latch assembly from the latched configuration to the unlatched configuration, the actuation system including an electromagnet assembly magnetically coupled to the latch assembly; and
a control system operably coupled to the electromagnet assembly, the control system configured to magnetically uncouple the electromagnet assembly from the latch assembly to cause the latch assembly to move from the latched configuration to the unlatched configuration.

2. The latch apparatus of claim 1 wherein the electromagnet assembly includes:
a permanent magnet;
a ferromagnetic core;
an electromagnetic coil surrounding the ferromagnetic core to generate a magnetic flux, the control system magnetically uncoupling the permanent magnet from the latch assembly by delivering a short pulse of electrical power which generates the magnetic flux in the electromagnetic coil of a polarity opposite to a polarity of a magnetic flux generated by the permanent magnet.

3. The latch apparatus of claim 2 wherein the electromagnet assembly further comprises a secondary magnet, the secondary magnet having a same polarity as the polarity of the magnetic flux generated in the electromagnetic coil, which generates a rotary force to move the latch assembly from the latched configuration to the unlatched configuration.

4. The latch apparatus of claim 1 wherein the latch assembly comprises:
a strike rotationally movable between an unlatched strike position in which the latch assembly is in the unlatched configuration and a latched strike position in which the latch assembly is in the latched configuration;
a release lever rotationally movable between an unlatched release lever position in which the latch assembly is in the unlatched configuration and a latched release lever position in which the latch assembly is in the latched configuration; and
a lever arm that is magnetically coupled to the actuation system, the control system magnetically uncoupling the lever arm from the actuation system by delivering a short pulse of electrical power to cause the lever arm to rotatably move the release lever from the latched lever position to the unlatched lever position.

5. The latch apparatus of claim 4 wherein the latch assembly further comprises:
a stator device fixedly positioned relative to the strike member and the release lever, the stator device including a plurality of radially spaced apart recesses; and
a plurality of rollers, each one of the plurality of rollers sized and shaped to be moveably received in the respective plurality of recesses.

6. The latch apparatus of claim 5 wherein the strike member includes a plurality of radially spaced-apart strike member notches, the strike member notches sized and shaped to:
misalign with recesses of the stator device when the strike member is in the unlatched strike position; and
align with the recesses of the stator device when the strike member is in the latched strike position to receive therein portions of the rollers.

7. The latch apparatus of claim 5 wherein the release lever includes a plurality of radially spaced-apart lever notches, the lever notches sized and shaped to:
misalign with the recesses of the stator device when the release lever is in the latched release lever position; and
align with the recesses of the stator device when the release lever is in the unlatched release lever position to receive therein the rollers.

8. The latch apparatus of claim 4 wherein the strike member includes an aperture sized and shaped to receive a strike pin, rotary movement of the strike member from the latched strike position to the unlatched strike position causing the lever arm to rotationally move toward the electromagnet assembly.

9. The latch apparatus of claim 4 wherein the strike member moves from the latched strike position to the unlatched strike position in a first rotary direction, and the release lever moves from the latched release lever position to the unlatched release lever position in a second rotary direction which is opposite to the first rotary direction.

10. A latch apparatus coupleable to an aircraft component and having at least a latched configuration and an unlatched configuration, the latch apparatus comprising:
a latch assembly including:
a release lever movable between a first release lever position in which the latch apparatus is in the unlatched configuration and a second release lever position in which the latch apparatus is in the latched configuration; and
a lever arm coupled to the release lever;
a control system operable to generate a short pulse of electrical power;
an actuation system operably coupled to the control system, the actuation system including an electromagnet assembly having:
a ferromagnetic core;
an electromagnetic coil surrounding the ferromagnetic core to generate a magnetic flux; and
a permanent magnet, the short pulse of electrical power magnetically uncoupling the permanent magnet from the lever arm by generating the magnetic flux in the electromagnetic coil of a polarity opposite to a polarity of a magnetic flux of the permanent magnet, which causes rotary movement of the lever arm to move the release lever from the second release lever position to the first release lever position.

11. The latch apparatus of claim 10 wherein the electromagnet assembly further comprises:
a secondary magnet, the secondary magnet having a same polarity as the polarity of the magnetic flux generated in the electromagnetic coil, which generates a rotary force in the lever arm to cause the release lever to move from the second release lever position to the first release lever position.

12. The latch apparatus of claim 10 wherein the latch assembly further comprises:
a strike member having a first strike position when the latch apparatus is in the unlatched configuration and a second strike position when the latch apparatus is in the latched configuration, the strike member having a notch sized and shaped to receive a pin structure of the aircraft component, the pin structure contacting the strike member to rotatably move the strike member from the first strike position to the second strike position.

13. The latch apparatus of claim 12 wherein movement of the strike member from the first strike position to the second strike position causes the release lever to move from the first release lever position to the second release lever position.

14. The latch apparatus of claim 10 wherein the latch assembly further comprises:
a stator device fixedly positioned relative to the release lever, the stator device including a plurality of radially spaced apart recesses; and
a plurality of rollers, each one of the plurality of rollers sized and shaped to be moveably received in the respective recesses.

15. The latch apparatus of claim 14 wherein the release lever includes a plurality of radially spaced-apart lever notches, the lever notches sized and shaped to:
misalign with the recesses of the stator device when the release lever is in the second release lever position; and
align with the recesses of the stator device when the release lever is in the first release lever position to receive therein the rollers.

16. The latch apparatus of claim 14 wherein the latch assembly comprises a strike member having a first strike position when the latch apparatus is in the unlatched configuration and a second strike position when the latch apparatus is in the latched configuration, the strike member having a plurality of radially spaced apart strike member notches, the strike member notches sized and shaped to align with the recesses of the stator device when the strike member is in the second strike position.

17. A method for latching a payload component of an aircraft comprising:
rotating a strike member in a first rotary direction from an unlatched strike position to a latched strike position by contacting a structure of the aircraft with the strike member;
maintaining the latched strike position by coupling an electromagnet assembly having a permanent magnet and an electromagnet coil to a lever arm coupled to the strike member; and
unlatching the payload component by uncoupling the lever arm from the electromagnet assembly by delivering a short pulse of electrical power to the electromagnet assembly, the delivering generating a current induced magnetic flux in the electromagnet coil of a polarity opposite to a polarity of a magnetic flux generated by the permanent magnet to cause the lever arm to rotatably move the strike member in a second rotary direction from the latched strike position to the unlatched strike position.

18. The method of claim 17 wherein delivering a short pulse of electrical power to the electromagnet assembly causes a secondary magnet of the electromagnet assembly to generate a rotary force to rotate the lever arm in the first rotary direction.

19. The method of claim 17 wherein uncoupling the lever arm from the electromagnet assembly causes rotary movement of a release lever in the first rotary direction from a latched release lever position to an unlatched release lever position, the rotary movement causing the strike member to move in the second rotary direction from the latched strike position to the unlatched strike position.

20. The method of claim 17 wherein rotating the strike member in the first rotary direction from the unlatched strike position to the latched position causes one or more notches in the strike member to align with one or more rollers positioned in a stator device.
